(19) United States
(12) Patent Application Publication
(10) Pub. No.: US 2005/0070431 A1
(43) Pub. Date: Mar. 31, 2005

(54) Catalytic combustors

(75) Inventors: Mary Anne Alvin, Pittsburgh, PA (US); Basil Mucha, Wayne, PA (US); James Klotz, Quakerton, PA (US); Larry Campbell, Friendsville, TN (US); Gregory J. Wagner, Knoxville, TN (US); Michele Sanders, Knoxville, TN (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/992,183

(22) Filed: Nov. 18, 2004

Related U.S. Application Data
(63) Continuation-in-part of application No. 10/672,772, filed on Sep. 26, 2003.

(51) Int. Cl. B01J 21/04

(52) U.S. Cl. 502/439

(57) ABSTRACT

A coated article (e.g., 244) and a method for preparing a coating (e.g., 400) for a metallic substrate (402) are described. In one embodiment, the method includes preparing a ceramic powder comprising particles of a ceramic material (404) doped with a catalyst species (406). The method also includes adding metal particles (408) and the ceramic powder to a fluid to form a fluid suspension effective to maintain the catalyst species dispersed therein, and then applying the fluid suspension to the metallic substrate to form the coating thereon. In another embodiment, an aqueous suspension of undoped ceramic particles (316) may be combined with a fluid suspension of metallic particles to form the coating.

This application is a continuation-in-part of U.S. patent application Ser. No. 10/672,772 and it claims benefit of the Sep. 26, 2003 filing date thereof.

### FIELD OF THE INVENTION

The present invention relates generally to combustion gas turbine engines and, more particularly, to combustion gas turbine engines that employ catalytic combustion principles in the environment of a lean premix burner.

### BACKGROUND OF THE INVENTION

As is known in the relevant art, combustion gas turbine engines typically include a compressor section, a combustor section and a turbine section. Large quantities of air or other gases are compressed in the compressor section and are delivered to the combustor section. The pressurized air in the combustor section is then mixed with fuel and combusted. The combustion gases flow out of the combustor section and into the turbine section where the combustion gases power a turbine and thereafter exit the engine. Commonly, the turbine section includes a shaft that drives the compressor section, and the energy of the combustion gases is greater than that required to run the compressor section. As such, the excess energy is taken directly from the turbine/compressor shaft to typically drive an electrical generator or may be employed in the form of thrust, depending upon the specific application and the nature of the engine.

As is further known in the relevant art, some combustion gas turbine engines employ a lean premix burner that mixes air with the fuel to result in an extremely lean-burn mixture. Such a lean-burn mixture, when combusted, beneficially results in the reduced production of nitrogen oxides (NOₓ), which is desirable in order to comply with applicable emission regulations, as well as for other reasons.

The combustion of such lean mixtures can, however, be somewhat unstable. Catalytic combustion principles have been applied to such lean combustion systems. Catalytic combustion techniques typically involve preheating a mixture of fuel and air and flowing the preheated mixture over a catalytic material that may be in the form of a noble metal such as platinum, palladium, rhodium, iridium or the like. When the fuel/air mixture physically contacts the catalyst, the fuel/air mixture spontaneously begins to combust. Such combustion raises the temperature of the fuel/air mixture, which in turn enhances the stability of the combustion process. The requirement to preheat the fuel/air mixture to improve the stability of the catalytic process reduces the efficiency of the operation. A more recent improvement splits the compressed air that ultimately contributes to the lean-burn mixture into two components; mixing approximately 10-20% with the fuel that passes over the catalyst while the remainder of the compressed air passes through a cooling duct, which supports the catalyst on its exterior wall. The rich fuel/air mixture burns at a much lower temperature upon interaction with the catalyst and the coolant air flowing through the duct functions to cool the catalyst to prevent its degradation. Approximately 20% of the fuel is burned in the catalytic stage and the fuel-rich air mixture is combined with the cooling gas just downstream of the catalytic stage and ignited in a second stage to complete combustion and form the working gas for the turbine section.

In previous catalytic combustion systems, the catalytic materials typically were applied to the outer surface of a ceramic substrate to form a catalytic body. The catalytic body was then mounted within the combustor section of the combustion gas turbine engine. Ceramic materials were often selected for the substrate in as much as the operating temperature of a combustor section typically can reach 1327° C. (2420° F.), and ceramics were considered as the best substrate for use in such a hostile environment, based on considerations of cost, effectiveness and other considerations. In some instances, the ceramic substrate was in the form of a ceramic washcoat applied to an underlying metal substrate, the catalyst being applied to the ceramic washcoat.

The use of such ceramic substrates for the application of catalytic materials has not, however, been without limitation. When exposed to typical process temperatures within the combustor section, the ceramic washcoat can be subjected to spalling and/or cracking due to poor adhesion of the ceramic washcoat to the underlying metal substrate and/or mismatch in the coefficients of thermal expansion of the two materials. Such failure of the ceramic washcoat subsequently reduces catalytic performance. It is thus desired to provide an improved catalytic body that substantially reduces or eliminates the potential for reduced catalytic performance due to use of ceramic materials.

In certain lean premix burner systems, such as the two-stage catalytic combustors described above, oxidation of the advanced nickel-based alloys, such as Haynes ^{RTM}230™ and Haynes ^{RTM}214™ commonly employed as the substrate for the ceramic washcoat, at temperatures of 900° C. (1650° F.), not only lead to the formation of either chromia- or alumina-enriched external oxide layer, but also to internal oxidation of the metal substrate. With time, the unaffected cross-sectional wall thickness area of the catalytic combustion substrate tubes decreases and gives rise to a potential reduction in the ultimate load-bearing capabilities of the substrate tube. It is thus desired that an improved catalytic body be provided, that can be used in conjunction with such a multistage combustor section without exhibiting such oxide degradation.

### BRIEF DESCRIPTION OF THE DRAWINGS

A further understanding of the invention can be gained from the following description of the preferred embodiments when read in conjunction with the accompanying drawings in which:

FIG. 1 is a cross-sectional view of a combustion turbine for which a catalytic combustor of the present invention will be used;

FIG. 2 is a side cross-sectional view of one embodiment of a catalytic combustor according to the present invention;

FIG. 3 is a cross-sectional side view of the catalytic combustor embodiment of FIG. 2, focusing on the catalyst supporting tubes;

FIG. 4 is a side cutaway view of another embodiment of a catalytic combustor according to the present invention; and

FIG. 5 is a schematic view of a catalytic section of a combustor illustrating the coating on the metal substrate.

FIG. 6 shows a metal alloy substrate including a bonding layer formed between the substrate and a coating applied on the substrate.

FIG. 7 is a schematic view of a metal alloy substrate having a coating including ceramic particles doped with a catalyst species in a matrix of metallic particles.

FIG. 8. shows a metal alloy substrate including a matallic-ceramic catalytic layer and a catalytic washcoat layer.

FIG. 9 shows a metal alloy substrate including a metallic-ceramic layer, a metallic-ceramic catalytic layer, and a catalytic washcoat layer.

### DETAILED DESCRIPTION OF THE INVENTION

The preferred embodiment of this invention is a catalyst supporting structure for a catalytic combustor. The catalyst supporting structure provides for improved bonding of the catalyst-containing coating with the underlying metal substrate, and renders the metal support structure resistant to oxidation that would otherwise degradate the support capability of the structure over time.

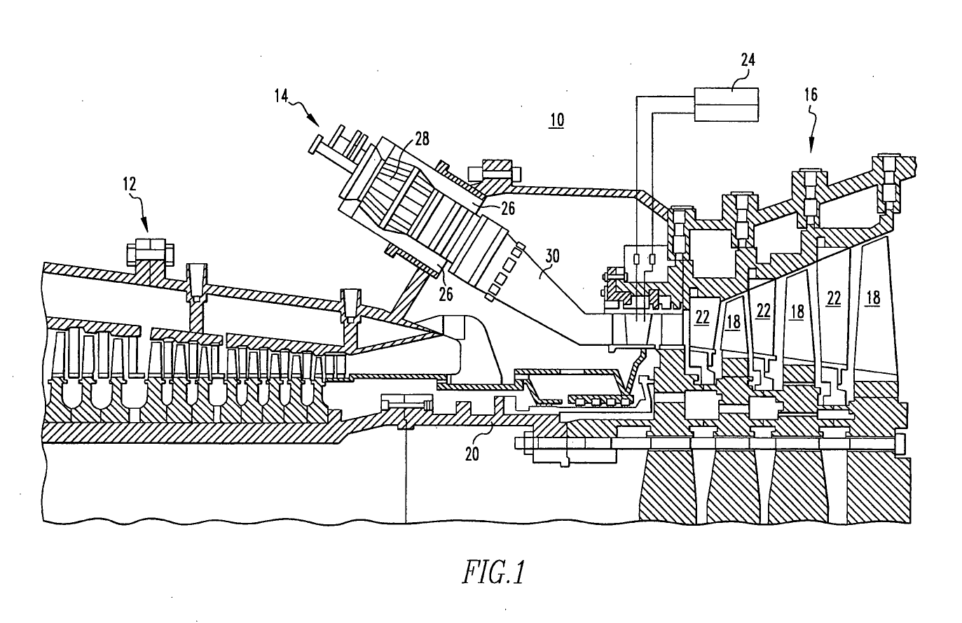

FIG. 1 illustrates a combustion turbine 10. The combustion turbine 10 includes a compressor section 12, at least one combustor 14, and a turbine section 16. The turbine section 16 includes a plurality of rotating blades 18, secured to a rotatable central shaft 20. A plurality of stationery vanes 22 are positioned between the blades 18, with the vanes 22 being dimensioned and configured to guide a working gas over the blades 18.

In use, air is drawn in through the compressor 12, where it is compressed and driven towards the combustor 14, with the air entering through air intake 26. From the air intake 26, the air will typically enter the combustor at combustor entrance 28, wherein it is mixed with fuel. The combustor 14 ignites the fuel/air mixture, thereby forming a working gas. This working gas will typically be approximately 1327° C. to 1593° C. (2420° F. to 2900° F.). The working gas expands through the transition member 30, through the turbine 16, being guided across the blades 18 by the vanes 22. As the gas passes through the turbine 16, it rotates the blades 18 and shaft 20, thereby transmitting usable mechanical work through the shaft 20. The combustion turbine 10 also includes a cooling system 24 dimensioned and configured to supply a coolant, for example, steam or compressed air, to the blades 18, vanes 22 and other turbine components.

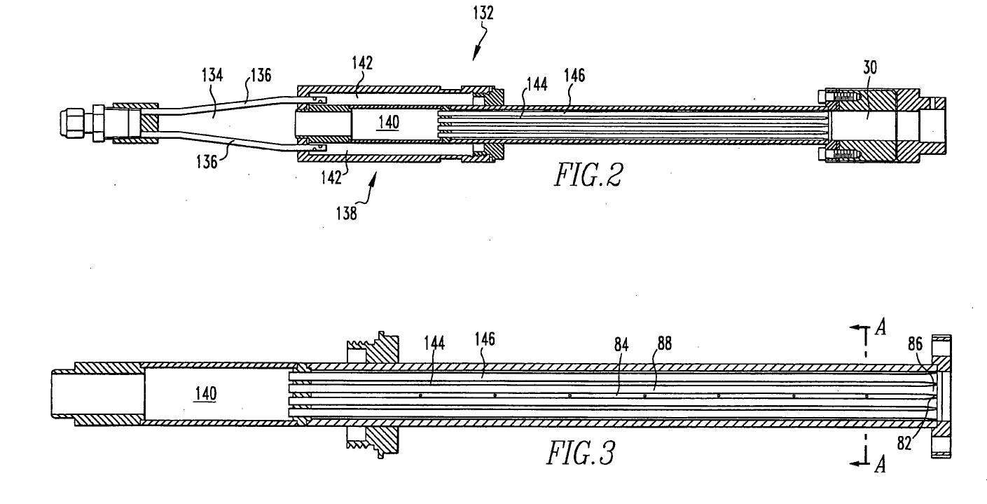

FIGS. 2 and 3 illustrate one embodiment of a catalytic assembly portion of a catalytic combustor. In the following description, two digit numbers refer to the general components in the various figures and three digit numbers refer to the component of a specific embodiment. The catalytic assembly portion 132 includes an air inlet 134 and a fuel inlet 136. The fuel and air are directed from the air inlet 134 and fuel inlet 136 into a mixer/separator chamber 138. A portion of the air becomes the cooling air, traveling through the central cooling air passage 140. The remaining air is directed towards the exterior mixing chamber 142, wherein it is mixed with fuel from the fuel nozzles 136. The catalyst-coated channels 144 and cooling air channels 146 are located downstream of the mixer/separator portion 138, with the catalyst-coated channels 144 in communication with the mixing chambers 142 and the uncoated cooling channels 146 in communication with the cooling air chamber 140. A fuel-rich mixture is thereby provided to the catalyst-coated channels, resulting in a reaction between the fuel and catalyst without a preburner, and heating the fuel/air mixture. Upon exiting the catalyst-coated channels 144 and cooling channels 146, the fuel/air mixture and cooling air mix within the transition member 30, thereby providing a fuel-lean mixture at the point of ignition expanding towards the turbine blades as the fuel/air mixture is ignited and burned in the second stage.

Referring to FIG. 3, the end portions 86 of the tubular assemblies 146 are flared with respect to the central portion 88 of the tubular assembly 146. An alternate preferred embodiment described in U.S. patent application Ser. No. 10/319,006, filed Dec. 13, 2002 (Attorney Docket No. 2002P19398US), “Catalytic Oxidation Module for a Gas Turbine”—Bruck et al., teaches the use of non-flared tubes. This channel profile provides for sufficient flow of the fuel/air mixture to prevent backflash (premature ignition of fuel in the combustor).

The alternating channels are configured so that one set of channels will include a catalytic surface coating, and the adjacent set of channels will be uncoated, thereby forming channels for cooling air adjacent to the catalyst-coating channels. These alternating channels may be formed by applying the catalytic coating to either the inside surface or the outside surface of tubular subassemblies. One preferred embodiment described in U.S. patent application Ser. No. 09/965,573, filed on Sep. 27, 2001 (Attorney Docket No. 01 P17905US), applies the catalytic coating to the outside surfaces of the top and bottom of each rectangular, tubular subassembly, which are then stacked in a spaced array, so that the catalyst-coated channels 144 are formed between adjacent, rectangular, tubular subassemblies, and the cooling air channels are formed within the rectangular, tubular subassemblies. Some preferred catalyst materials include platinum, palladium, ruthenium, rhodium, and the like.

Referring to FIGS. 2 and 3, in use, air exiting the compressor 12 (FIG. 1) will enter the air intake 26, proceeding to the air inlet 134 shown in FIG. 2. The air will then enter the cooling air plenum 140, with some air entering the cooling channels or ducts 146, and another part of the air entering the mixing chamber 142, wherein it is mixed with fuel from the fuel inlet 136. The fuel/air mixture will then enter the catalyst-coated channels 144. The fuel/air mixture may enter the catalyst-coated channels 144 in a direction perpendicular to the elongated dimension of these channels, turning downstream once it enters the catalyst-coated channels 144. The catalyst will react with the fuel, heating the fuel/air mixture. At the air outlet 30, the fuel/air mixture and cooling air will mix, the fuel will be ignited, and the fuel/air mixture will then expand into the blades 18 of the turbine 16 shown in FIG. 1.

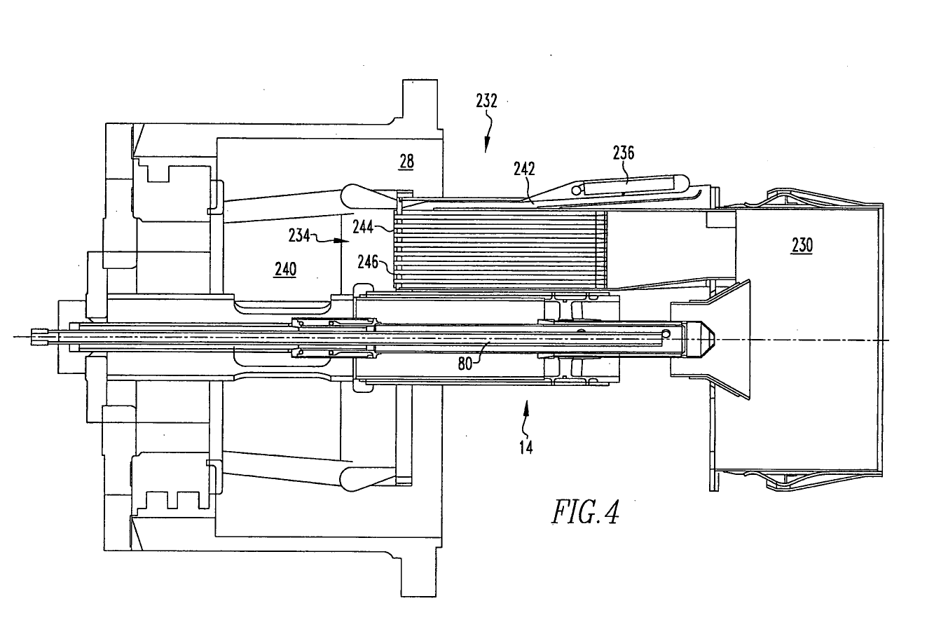

Referring to FIG. 4, a second embodiment of the catalytic combustor 14 is illustrated, which shows the catalyst assembly 232 housed in an environment of a two-stage combustor 14. The catalytic assembly portion 232 includes an air inlet 234, and a fuel inlet 236. Pilot nozzle 80 passes axially through the center of the combustor 14, serving as both an internal support and as an ignition device at the transition member 230. In the embodiment shown in FIG. 4, a portion of the air is separated to become cooling air and travels through the cooling air passage to the plenum 240. The remaining air is directed towards the mixing plenum 242 wherein it is mixed with fuel provided by the fuel inlet 236. The catalyst-coated channels 244 are in communication with the mixing plenums 242 and the uncoated cooling channels 246 are in communication with the cooling air plenum 240. The fuel/air mixture may enter the catalyst-coated channels 244 in a direction substantially perpendicular to these channels, turning downstream once the fuel/air mixture enters the catalyst-coated channels 244. A fuel-rich mixture is thereby provided to the catalyst-coated channels, resulting in a reaction between the fuel and catalyst without a preburner, and heating the fuel/air mixture. Upon exiting the catalyst-coated channels 244 and cooling channels 246, the fuel/air mixture and the cooling air mix within the transition member 230, thereby providing a fuel-lean mixture at the point of ignition, expanding towards the turbine blades as the fuel-lean mixture is ignited and burned. In a typical prior art first-stage catalytic combustor, the catalyst is supported along a ceramic washcoat layer that is deposited along the outer surface of a 4.76 mm (0.19 in.) diameter, approximately 250 micrometer thick metal tubes typically constructed from Haynes ^{RTM} alloys 214 ™ or 230 ™, a product of Haynes ^{RTM} International, Inc., headquartered in Kokomo, Ind. Compressor discharge air is introduced into the module at temperatures of approximately 375° C.-410° C. (710° F.-770° F.). 80-90% of the compressor air is channeled along the inside diameter bore or uncoated surface of the catalytic combustion tubes, while 10-20% of the compressor air combines with the incoming fuel. The rich fuel/air mixture passes over the outside diameter catalytically-coated surface of the tubes, initiating light-off at temperatures of between 290° C. and 360° C. (555° F.-680° F.), achieving partial combustion, i.e., 10-20% of the fuel. The air, which is introduced along the inside diameter bore of the tubes, cools and maintains the catalytic reaction temperature. Under rich fuel conditions, temperatures of 760° C.-870° C. (1400° F.-1600° F.) are typically achieved at the outlet of the first-stage catalytic combustor. Air flowing along the inside diameter surface of the tubes then combines with the partially converted, fuel-rich process gas, producing a fuel-lean gas composition. The fuel-lean gas mixture raises the exhaust gas temperature to 1260° C. to 1480° C. (2300° F.-2700° F.), while achieving complete fuel conversion to a working gas to drive the turbine section 16 through 100% combustion.

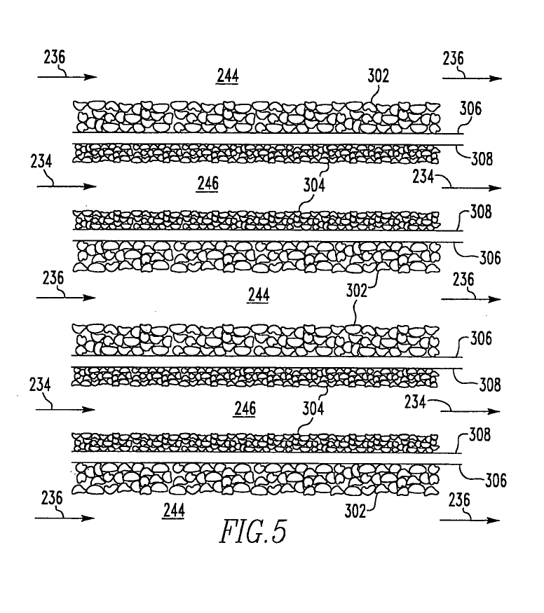

Tests have shown that oxidation of the advanced nickel-based alloys such as Haynes ^{RTM} 230 ™ and Haynes ^{RTM}214 ™ at temperatures of 900° C. (1650° F.) will not only lead to the formation of either a chromia- or alumina-enriched external oxide layer, but also to internal oxidation of the metal substrate. With time, the unaffected cross-sectional wall thickness area of the catalytic combustion substrate tubes decreased, likely resulting in a reduction in the ultimate load-bearing capabilities of the substrate tube. In order to prevent surface oxidation, internal metal wall oxidation, and a possible reduction of the load-bearing area of the catalytic combustion support tubes from occurring, this invention applies a coating to the walls of the cooling air channel, which is preferably, but not required to be, the inside diameter surface of the tubes, which is in direct contact with the flowing air (FIG. 5).

The primary function of the coating 304 along the inside surface 308 of the tube, rectangular assembly, or duct (FIG. 5), is protection of the metal substrate from both surface and internal oxidation during process operation. The coating structure achieves an internal diffusion barrier zone within the metal substrate inherently by aluminizing the substrate metal through the molecular interaction of nickel and other elements from within the Haynes ^{RTM} 230 ™ or Haynes ^{RTM} 214 ™ substrate with aluminum from the applied coating. This interaction forms a complex nickel aluminide zone at the metal substrate/coating interface. This dense zone provides exceptional thermal and oxidative protection to the substrate metal.

Compositionally similar to the coating applied to the inside surface 308 of the tube, rectangular assembly, or duct, the coating 302 applied to the external surface 306 of said components (FIG. 5), within the cross-sectional thickness of the applied coating, is a porous structure. This porous, matrix-like structure can contain suspended metal or catalyst species. The catalyst species include, but are not limited to the use of Pt, Pd, Ir, Ru, Rh, Os and the like, formed through the addition of metal nanoparticles, and/or crystallites, and/or through the reduction/dissociation of chloride, nitrate, amine, phosphate, and the like, precursor phases. This coating is both chemically and mechanically adhered to the metal substrate. It is inorganic and can also contain various oxides such as, but not limited to, alumina, titania, zirconia, ceria and so on. These materials can be used to modify other properties of the coating such as catalytic activity, ductility, conductivity, etc. An aluminum-containing coating that can be used for this purpose is a chrome-phosphate-bonded aluminum coating, available from Coating Technology, Inc., Malvern, Pa., and Coatings for Industry, Inc., Souderton, Pa. Preferably, the base metal of the tubes rectangular assemblies or ducts are either lightly abraded prior to application of the coating to provide microscopic ridges and valleys for enhanced mechanical interlocking of the applied coating layer, or oxidized to initiate the formation of a non-smooth chromia-alumina-enriched surface layer, or abraded, followed by oxidation. In this manner, the applied diffusion barrier coating is considered to have a two-fold advantage over that of the current ceramic washcoat technology. First of all, the diffusion barrier coating reduces the surface metal and/or internal wall oxidation. Secondly, the coating's inherent bonding to the underlying substrate is both mechanical as well as chemical in nature, and provides a much stronger attachment than that of the ceramic washcoat. Additionally, there is a third advantage in that the aluminum-enriched matrix formed throughout the coating is capable of serving as a porous substrate on or into which the catalyst is introduced. Additionally, a more densified diffusion barrier coating is applied to the inside diameter surface of the catalytic combustion tube than is applied to the outside surface of the tube. Densification can be achieved through the use of a finer particle size or higher loading of metal and/or ceramic or metal oxide particles, thus reducing open porosity within the applied diffusion barrier layer. The resulting densified layer limits oxygen diffusion to the metal substrate, protecting the cooling air channels from oxidation. The density of the non-catalytic coating can be approximately between 10% to 50% denser and preferably 25% denser than the catalytic coating.

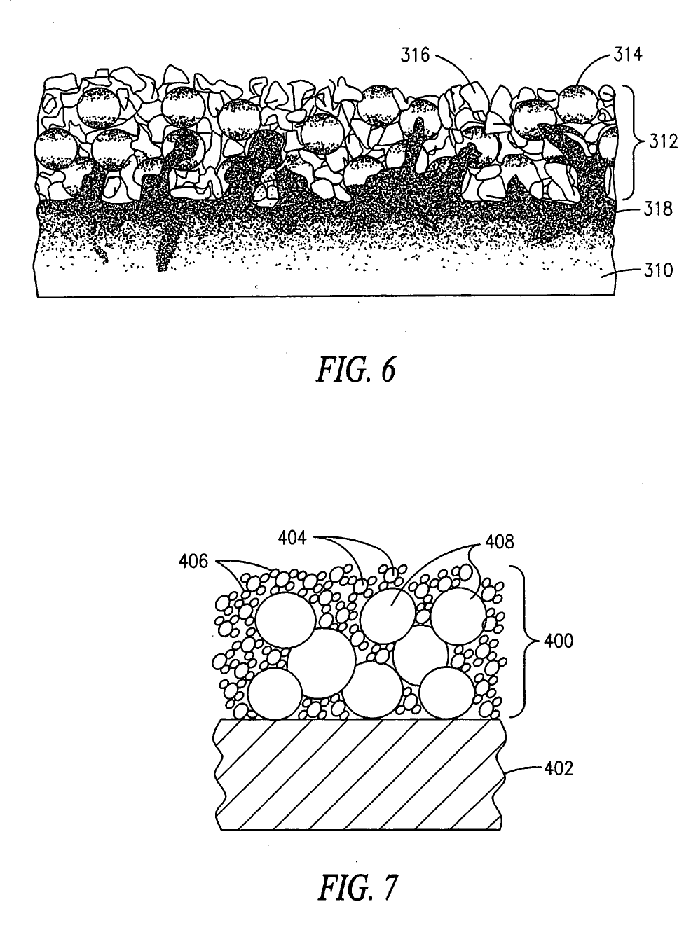

As described above with regard to FIG. 5, the coatings 302, 304 incorporating aluminum particles provide improved adherence to a metal alloy substrate, such as Haynes ^{RTM} 230 ™ or Haynes ^{RTM} 214 ™ alloy, by aluminizing the substrate alloy via a molecular interaction of nickel and other elements in the alloy with the aluminum from the applied coating 302, 304. Advantageously, the resulting nickel aluminide intermetallic and/or spinel phase chemical bonding provides thermal and oxidative protection to the underlying substrate. FIG. 6 shows such a metal alloy substrate 310 coated with a coating 312 including a matrix of aluminum particles 314 and ceramic oxide particles 316 and includes a bonding layer 318, such as the in-situ formed nickel aluminide intermetallic and/or spinel phase layer, resulting between the metal alloy substrate 310 and coating 312.

An innovative method for forming such a coating 312 that results in a protective bonding layer 318 between the substrate 310 and the coating 312 includes creating a suspension of ceramic oxide particles in a fluid medium where surface polymerization and bonding results between adjacent ceramic particles such as when undergoing a heating step. For example, ceramic oxide particles may be added to an aqueous solution to form a fluid suspension of hydrated ceramic particles capable of forming a network or polymerization of adjacent/adjoining ceramic particles, such as after being heated at a temperature of at least 125° C. (260° F.). In an embodiment, the ceramic particles 316 included in the suspension may range in size from 10 nanometers to 10 micrometers, and may preferably range in size from 0.1 micrometers to 5 micrometers, and may more preferably range in size from 0.1 micrometers to 1 micrometer. The method further includes combining the first fluid suspension ceramic particles 316 with a second fluid suspension of metal particles 314, such as aluminum particles, to form a mixed fluid suspension. For example, the metal particles 314 used in the second suspension may range in size from 0.01 micrometers to 10 micrometers, and may preferably range in size from 0.1 micrometers to 10 micrometers, and may more preferably range in size from 0.1 micrometer to 5 micrometers. The resulting mixture may then be applied to a metal alloy substrate 310 to form a metal-ceramic coating 312 on the substrate 310 so that the metal particles in the metal-ceramic layer 312 react with the metal alloy of the substrate 310 to form a diffusion barrier layer 318 between the metal alloy substrate 310 and the metal-ceramic layer 312. Advantageously, the intermetallic and/or spinel phase barrier layer 318 provides thermal and oxidative protection to the underlying substrate 310.

In a further aspect of the invention, the metal-ceramic layer 312 may be made catalytically active by addition of a catalyst species. In the past, catalytic coatings, such as catalytic washcoats, have been formed by preparing a fluid suspension of ceramic particles to serve as a support carrier for a catalyst species. A fluid solution of a dissolved or colloidal catalyst species is then prepared and added to the fluid suspension of ceramic particles to form a fluid mixture having the catalyst species co-dispersed among the ceramic particles. The mixture is then applied to a substrate and cured, such as by using a process of calcining. However, using this conventional process, the catalyst species may agglomerate or coalesce within the mixture forming localized concentrations of catalyst species within the mixture. When applied to a substrate, agglomeration of the catalyst within the coating reduces catalytic activity of the applied coating. In another aspect, the metal-ceramic layer 312 may be applied to the surface of the metal substrate 310. After fully or partially calcining the metal-ceramic layer 312 applied as a washcoat, a catalyst-containing solution may be incipient wetted onto a surface of the metal-ceramic layer 312, whereby the catalyst resides along the surface as well as infiltrating into pores of the metal-ceramic layer 312.

The inventors have developed an innovative method of preparing a catalytic coating to achieve improved dispersion of a catalytic species within a catalytic coating. The method may be used to form the metallic ceramic catalytic coating described previously for coating nickel-based alloys substrates used in catalytic combustors. The method includes first preparing a ceramic powder comprising particles of a ceramic material doped with a catalyst species. Doped, as used herein, means that a catalyst species has been associated with each of the particles of the ceramic material by methods such as chemically binding the catalyst species to or within the ceramic particles or physically attaching the catalyst species to the particles. For example, chemically binding catalyst species to the ceramic particles may include using an ion exchange method as described in U.S Pat. No. 6,207,130. Accordingly, ions of a catalyst species may be implanted within a ceramic chemical structure, such as a hexa-aluminate of the form MAI₁₁O₁₈ or MAI₁₂O₁₉, where M may include a catalyst species such as platinum (Pt) or palladium (Pd) and the resulting doped hexa-aluminate particles may be used to prepare the ceramic powder.

Physically binding the catalyst species to the ceramic particles may include impregnating particles of the catalyst species into respective surfaces of the particles of a ceramic material, for example, by combining a fluid suspension of ceramic particles and fluid suspension of catalyst species particles and calcining the resulting fluid suspension mixture, causing the particles of the catalyst species to become adhered to the surfaces of respective ceramic particles, such as by being impregnated into cracks and crevices in the surfaces. In an aspect of the invention, the catalyst species particles, or catalytic crystallites, may range in size from less than 1 nanometer to 1 micrometer, and may preferably range in size from 1 nanometer to 10 nanometers. The ceramic particles may range in size from about 10 nanometers to about 10 micrometers, and may preferably range in size from 0.1 micrometers to 5 micrometers, and may more preferably range in size from 0.1 micrometers to 1 micrometer.

The method further includes preparing a fluid suspension, such as an aqueous suspension, of the doped ceramic particles having a desired ceramic particle concentration. For example, the ceramic particle concentration may range from about 50% to 75%. The fluid suspension of the doped ceramic particles is combined with metal particles (such as aluminum particles) to form a mixed fluid suspension having a desired metal particle concentration. For example, the mixed fluid suspension may have a metal particle concentration ranging from about 25% to 50%. In an aspect of the invention, the metal particles may range in size from 0.01 micrometers to 10 micrometers, and may preferably range in size from 0.1 micrometers to 10 micrometers, and may more preferably range in size from 0.1 micrometers to 5 micrometers. Because the catalyst species are associated with the ceramic particles prior to forming the fluid suspension of the particles, the catalyst species remain associated with the ceramic particles and agglomeration of the catalyst species is reduced compared to conventional methods of mixing suspensions of ceramic particles and catalyst species solutions and/or through the use of incipient wetting techniques. In an embodiment of the invention, a binding agent, such as chromium phosphate, may be added to any of the above described suspensions to form a chemical bonding network between the ceramic particles. In another embodiment, the doped ceramic particles (such as alumina, titania, zirconia, ceria, and the like) and/or hexa-aluminate particles are combined with metal particles (such as aluminum particles) and a binder, such as a chromium phosphate, to enhance the catalytic activity of a metallic-ceramic catalytic combustion system such as described above.

The resulting mixed fluid suspension is then applied to a metallic substrate 402 (such as a Haynes ^{RTM} 230 ™ or Haynes ^{RTM} 214 ™ nickel alloy) to form a metallic ceramic catalytically active layer 400 as depicted in FIG. 7. The applied layer 400 may then be heat cured, for example, at a temperature greater than 600° C. (1110° F.). The layer 400 depicted in FIG. 7 and formed using the above described method shows catalyst species 406 associated with respective ceramic particles 404, such as Al₂O₃, ZrO₂, TiO₂, and CeO₂. The catalyst species 406 remains uniformly distributed throughout the layer 400 among a matrix of the metal particles 408, thereby providing improved catalytic activity of the layer 400 compared to layers prepared using conventional techniques that may frequently result in agglomeration of the catalyst species.

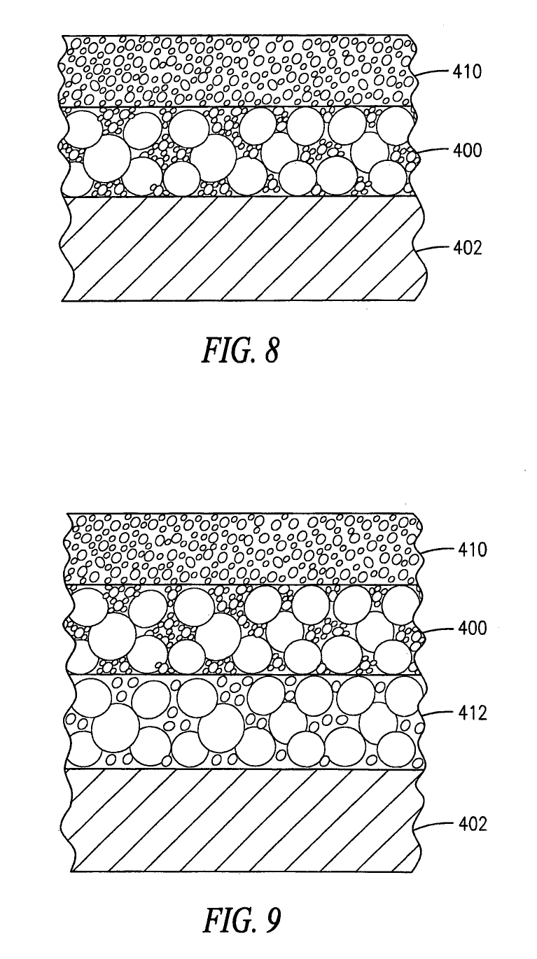

In an aspect of the invention depicted in FIG. 8, another catalytically active layer 410 may be applied over layer 400, such as by using the known methods of spraying or dip coating a catalytic washcoat on layer 400, for example, after layer 400 has been allowed to dry sufficiently to allow application of layer 410. The layers 400, 410 may then be heat cured, such as by a process of calcining at a temperature greater than 600° C. (1110° F.). In another embodiment, layer 400 may be heat cured and the catalytically active layer 410 may be applied over the cured layer 400 using a known incipient wetting technique promoting wicking of the layer 410 into underlying layer 400, thereby providing tenacious bonding between the layers 400, 410 and the surface of the metal substrate 402.

In an aspect of the invention depicted in FIG. 9, a bond layer 412, for example, containing metallic particles and ceramic particles, may be applied to the substrate before applying the metal ceramic catalytic layer 400. Layer 412 may be prepared using the method described previously for forming layer 400, but without including a catalyst species associated with the ceramic particles. In yet another embodiment, the bond layer may be a thermal barrier coating (TBC) layer. After application of the bond layer 412, the metal ceramic catalytic layer 400 may then be applied over layer 412 to form a catalytically active layer. In another aspect of the invention, another catalytically active layer 410 may be applied over layer 400 using, for example, the techniques described above with regard to FIG. 8.

While specific embodiments of the invention have been described in detail, it will be appreciated by those skilled in the art that various modifications and alternatives to those details could be developed in light of the overall teachings of the disclosure. For example, the catalyst described as being applied to the outside diameter surface of the catalytic tubes could be applied instead, or as well as, to the inside diameter surface with the cooling air passing over the outside diameter surface. Additionally, the terms “tubes” and “channels” have been used interchangeably and shall also encompass ducts or other conduits of any geometric shape that can be employed for the foregoing described purpose. Accordingly, the particular embodiments disclosed are meant to be illustrative only and not limiting as to the scope of the invention, which is to be given the full breath of the appended claims and any and all equivalents thereof.

1. A method comprising:
preparing a ceramic powder comprising particles of a ceramic material doped with a catalyst species;
adding metal particles and the ceramic powder to a fluid to form a fluid suspension effective to maintain the catalyst species dispersed therein; and
applying the fluid suspension to a metallic substrate to form a coating thereon.

2. The method of claim 1, wherein preparing the ceramic powder comprises chemically binding the catalyst species to particles of a hexa-aluminate ceramic.

3. The method of claim 1, wherein preparing the ceramic powder comprises impregnating particles of the catalyst species into respective surfaces of the particles of a ceramic material.

4. The method of claim 3, wherein the catalyst species range in size from 1 nanometer to 1 micrometer.

5. The method of claim 3, wherein the catalyst species range in size from 1 nanometer to 10 nanometers.

6. The method of claim 1, wherein the metal particles range in size from 0.01 micrometers to 10 micrometers.

7. The method of claim 1, wherein the metal particles range in size from 0.1 micrometers to 10 micrometers.

8. The method of claim 1, wherein the metal particles range in size from 0.1 micrometers to 5 micrometers.

9. The method of claim 1, wherein the particles of the ceramic material range in size from 10 nanometers to 10 micrometers.

10. The method of claim 1, wherein the particles of the ceramic material range in size from 0.1 micrometers to 5 micrometers.

11. The method of claim 1, wherein the particles of the ceramic material range in size from 0.1 micrometers to 1 micrometer.

12. The method of claim 1, further comprising adding a binder to the fluid suspension.

13. The method of claim 1, further comprising applying a ceramic washcoat after applying the fluid suspension to the metallic substrate.

14. The method of claim 1, further comprising:
heat curing the fluid suspension applied to the metallic substrate to form a cured layer; and
applying a ceramic washcoat over the cured layer.

15. The method of claim 1, further comprising applying the fluid suspension to a metallic substrate previously coated with a layer of material comprising metal particles and ceramic particles.

16. The method of claim 15, further comprising applying a ceramic washcoat after applying the fluid suspension to the previously coated metallic substrate.

17. A method comprising:
adding ceramic particles to an aqueous solution to form a first fluid suspension of hydrated ceramic particles capable of forming chemical bonds among the hydrated ceramic particles;
combining the first fluid suspension with a second fluid suspension of metal particles to form a third fluid suspension;
applying the third fluid suspension to a metal alloy substrate to form a metal-ceramic layer on the substrate; and
allowing the metal particles in the metal-ceramic layer to react with the metal alloy substrate to form a diffusion barrier layer between the metal alloy substrate and the metal-ceramic layer.

18. The method of claim 17, wherein the diffusion barrier layer comprises one of a spinel layer and an intermetallic layer.

19. The method claim 17, further comprising heating the first fluid suspension at a temperature of at least 125° C. after adding the ceramic particles to the aqueous solution.

20. A coated article comprising:
a metallic substrate;
a first layer, disposed over the metallic substrate and comprising and a plurality of ceramic particles doped with a catalyst species dispersed among a matrix of metal particles; and
a second layer, disposed over the first layer and comprising a catalyst-containing ceramic washcoat.

21. The coated article of claim 20, further comprising an intermediate layer between the metallic substrate and the first layer comprising a second plurality of ceramic particles dispersed among a second matrix of the metal particles.
